(19) United States
(12) Patent Application Publication
(10) Pub. No.: US 2023/0217293 A1
(43) Pub. Date: Jul. 6, 2023

(54) WIRELESS COMMUNICATION DEVICE, WIRELESS NETWORK DEVICE, WIRELESS COMMUNICATION SYSTEM, BRIDGE SYSTEM, CONTROL CIRCUIT, STORAGE MEDIUM, AND LOG INFORMATION SYNCHRONIZATION METHOD

(71) Applicant: Mitsubishi Electric Corporation, Tokyo (JP)

(72) Inventors: Ryo MATSUNAGA, Tokyo (JP); Masao OGA, Tokyo (JP); Yusuke KINOSHITA, Tokyo (JP); Keijiro TAKE, Tokyo (JP)

(73) Assignee: Mitsubishi Electric Corporation, Tokyo (JP)

(21) Appl. No.: 18/181,804

(22) Filed: Mar. 10, 2023

Related U.S. Application Data
(63) Continuation of application No. PCT/JP2020/043227, filed on Nov. 19, 2020.

(51) Int. Cl. H04W 24/10; H04W 56/00

(52) U.S. Cl. CPC H04W 24/10; H04W 56/001

(57) ABSTRACT

A wireless communication device included in a wireless communication system together with a wireless network device includes: processing circuitry to measure traffic transferred between the wireless network device and a time sensitive network, the processing circuitry performing wireless communication with the wireless network device and wired communication with the time sensitive network; to estimate an estimated passage time of the traffic that has cyclicity among the traffic; to determine a log level by using a first log level, which is based on a difference between the estimated passage time of the traffic estimated and an actual passage time of the traffic measured, and a second log level acquired from the wireless network device; to collect log information at a collection frequency based on the log level; and to report the log information to the wireless network device at a reporting frequency based on the log level.

### CROSS-REFERENCE TO RELATED APPLICATION

This application is a continuation application of International Application PCT/JP2020/043227, filed on Nov. 19, 2020, and designating the U.S., the entire contents of which are incorporated herein by reference.

### BACKGROUND OF THE INVENTION

### 1. Field of the Invention

The present disclosure relates to a wireless communication device that forms a wireless communication system together with a wireless network device, the wireless network device, the wireless communication system, a bridge system, a control circuit, a storage medium, and a log information synchronization method.

### 2. Description of the Related Art

The 3rd Generation Partnership Project (3GPP) defines that, as a function of a 5th generation (5G) system, the 5G system is treated as a virtual bridge and supports time sensitive communication (TSC) between control devices placed in time sensitive networking (TSN) outside the 5G system. When the 5G system is treated as the bridge, the 5G system needs to be provided with TSN ports as many as the number of TSNs that the 5G system bridges.

In a case of operation management in which a wireless communication device in the 5G system collects information such as communication quality and a device condition as log information and aggregates the information in a wireless network device, there are possibilities that a load of the wireless communication device increases due to the collecting the log information, a wireless band is pressed due to reporting the log information to the wireless network device, and the like. To address such problems, Patent Literature 1 discloses a technique in which a wireless communication device transmits information indicating that the wireless communication device holds log information to a wireless network device, and transmits the log information when receiving a report request from the wireless network device, thereby reducing or preventing the wireless communication device from having an increased load and pressing a wireless link due to collecting and reporting the log information.

### Citation List

### Patent Literature

Patent Literature 1: Japanese Patent No. 6721878

When a wireless communication system being the 5G system is treated as a bridge, that is, one device, it is preferable that, at the time of anomaly, the wireless network device can acquire the log information synchronously from the wireless communication devices connected to the TSN ports. However, according to the conventional technique above, the collection timings of the log information of the wireless communication devices are not synchronized. This has caused a problem in that the wireless network device cannot acquire pieces of the log information mutually synchronized, that is, pieces of the log information at the same collection timing, from the wireless communication devices.

### SUMMARY OF THE INVENTION

To solve the above problem and achieve an object, the present disclosure is directed to a wireless communication device included in a wireless communication system together with a wireless network device. The wireless communication device includes: processing circuitry to measure traffic transferred between the wireless network device and a time sensitive network, the processing circuitry performing wireless communication with the wireless network device and wired communication with the time sensitive network; to estimate an estimated passage time of the traffic that has cyclicity among the traffic; to determine a log level by using a first log level, which is based on a difference between the estimated passage time of the traffic estimated and an actual passage time of the traffic measured, and a second log level acquired from the wireless network device; to collect log information at a collection frequency based on the log level; and to report the log information to the wireless network device at a reporting frequency based on the log level.

### BRIEF DESCRIPTION OF THE DRAWINGS

FIG. 1 is a diagram illustrating an example of a configuration of a bridge system according to the present embodiment.

FIG. 2 is a block diagram illustrating an example of a configuration of a wireless communication device according to the present embodiment.

FIG. 3 is a block diagram illustrating an example of a configuration of a wireless network device according to the present embodiment.

FIG. 4 is a table illustrating examples of parameters for a log level used in the wireless communication device and the wireless network device according to the present embodiment.

FIG. 5 is a diagram illustrating an example of calculating a difference Δ between an estimated passage time and an actual passage time of application traffic of a control device from the wireless network device to the wireless communication device in a wireless communication system according to the present embodiment.

FIG. 6 is a flowchart illustrating an operation in which the wireless communication device according to the present embodiment sets the log level.

FIG. 7 is a flowchart illustrating an operation in which the wireless communication device and the wireless network device according to the present embodiment determine the log level.

FIG. 8 is a flowchart illustrating an operation in which the wireless network device according to the present embodiment transmits a log-level-instruction-value to the wireless communication device.

FIG. 9 is a flowchart illustrating an operation in which the wireless communication device according to the present embodiment collects log information and reports the log information.

FIG. 10 is a sequence diagram illustrating an operation of changing the log level of each device in the wireless communication system in response to a report from the wireless communication device in the wireless communication system according to the present embodiment.

FIG. 11 is a sequence diagram illustrating an operation of changing the log levels of the wireless communication devices on the basis of the log-level-instruction-value from the wireless network device in the wireless communication system according to the present embodiment.

FIG. 12 is a diagram illustrating an example of a configuration of processing circuitry in a case where the processing circuitry included in the wireless communication device according to the present embodiment is implemented by a processor and a memory.

FIG. 13 is a diagram illustrating an example of processing circuitry in a case where the processing circuitry included in the wireless communication device according to the present embodiment includes dedicated hardware.

### DETAILED DESCRIPTION OF THE PREFERRED EMBODIMENTS

Hereinafter, a wireless communication device, a wireless network device, a wireless communication system, a bridge system, a control circuit, a storage medium, and a log information synchronization method according to an embodiment of the present disclosure will be described in detail with reference to the drawings.

### Embodiment

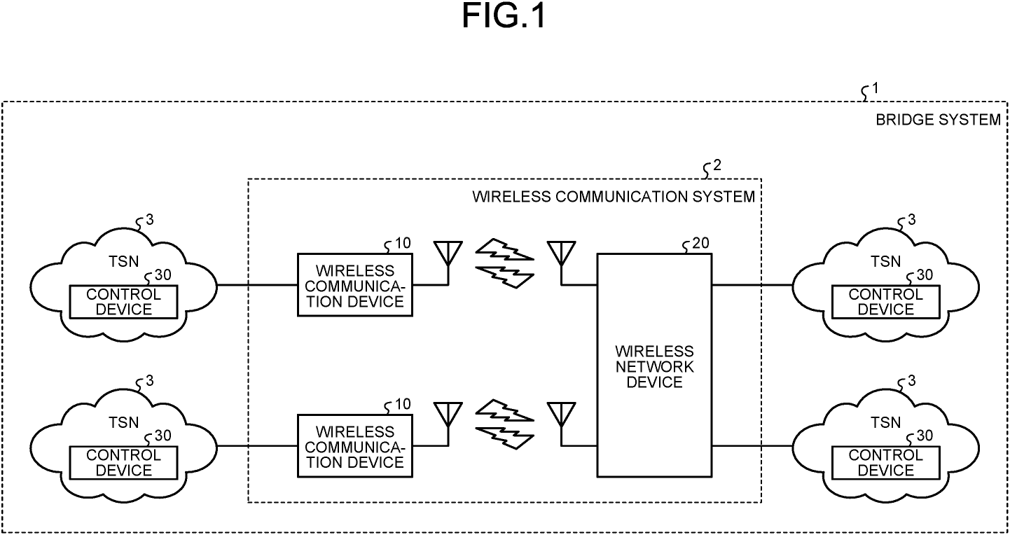

FIG. 1 is a diagram illustrating an example of a configuration of a bridge system 1 according to the present embodiment. The bridge system 1 includes a wireless communication system 2 and a plurality of TSNs 3. The bridge system 1 is a system in which the wireless communication system 2 including wireless communication devices 10 and a wireless network device 20 is treated as a virtual bridge. The bridge system 1 bridges the TSNs 3 by the wireless communication system 2, thereby establishing communication for applications between control devices 30 placed in the TSNs 3 deployed at different locations. The wireless communication system 2 operates as the bridge for the TSNs 3 and manages the wireless communication devices 10 and the wireless network device 20 as combinations of TSN ports. As described later, the wireless communication system 2 uniformly changes log levels of the wireless communication devices 10 and the wireless network device 20 and collects log information. The wireless communication system 2 as the bridge transfers application traffic between the control devices 30 placed in the different TSNs 3. The application traffic between the control devices 30 includes traffic transmitted in a regular cycle. In the following description, the TSN may be referred to as a time sensitive network.

The control device 30 is a device included in the TSN 3. For example, the control device 30 communicates with the control device 30 included in another one of the TSNs 3 in order to control a device in a factory. The applications used in the control devices 30 are roughly classified into those having regular cyclicity and those not having regular cyclicity, and a communication interval of each application is set according to requirements of each application. In order to perform high-precision time synchronization for the communication having regular cyclicity, communication traffic for time synchronization also has regular cyclicity. The wireless communication system 2 includes wired interfaces to be connected with the TSNs 3 to function as a TSN bridge in the bridge system 1. The wired interface is treated as a virtual TSN port in the wireless communication device 10 or the wireless network device 20.

The wireless communication device 10 has a function as a mobile terminal in the wireless communication system 2, and includes a wireless interface with the wireless network device 20 and the wired interface that is the TSN port. Moreover, in order for the wireless communication system 2 to be established as the TSN bridge, the wireless communication device 10 has time used in the wireless communication system 2 and time used in the TSN 3 together. The wireless communication device 10 further has a function of transferring, to the wired interface, the application traffic of the control device 30 received through the wireless interface, and a function of transferring, to the wireless interface, the application traffic of the control device 30 received through the wired interface. In addition, the wireless communication device 10 has a function of collecting and accumulating information such as wired communication quality, wireless communication quality, and device load as log information and reporting the log information to the wireless network device 20. In the following description, the application traffic of the control device 30 may be simply referred to as traffic.

The wireless network device 20 has a function of controlling the wireless communication system 2. Here, controlling the wireless communication system 2 includes managing wireless access, managing mobility, managing subscriber information, managing sessions, managing slices, managing policy and charging, and the like of the wireless communication device 10. The wireless network device 20 also has a function as a wireless base station, and performs wireless communication with the wireless communication device 10 through a wireless interface. The wireless network device 20 further has a function of transferring the application traffic of the control device 30, which is received from the wireless communication device 10 through the wireless interface, wirelessly to the wireless communication device 10 serving as the TSN port to which the control device 30 corresponding to an appropriate destination is connected, or to the wired interface of the wireless network device 20. The wireless network device 20 further has a function of wirelessly transferring the application traffic of the control device 30, which is received through the wired interface, to the wireless communication device 10 serving as the TSN port to which the control device 30 corresponding to an appropriate destination is connected. In addition, the wireless network device 20 accumulates the log information wirelessly received from the wireless communication device 10.

Note that FIG. 1 illustrates, as an example, two of the wireless communication devices 10 included in the wireless communication system 2, but the number of the wireless communication devices 10 is not limited thereto. The wireless communication system 2 may include three or more of the wireless communication devices 10. FIG. 1 also illustrates, as an example, the number of the TSNs 3 to which the wireless network device 20 is connected by wire is two, but the number of the TSNs 3 is not limited thereto. The wireless network device 20 may be connected by wire to three or more of the TSNs 3. FIG. 1 also illustrates, as an example, one control device 30 is included in each TSN 3, but the number of the control devices 30 is not limited thereto. Each TSN 3 may include two or more of the control devices 30 therein.

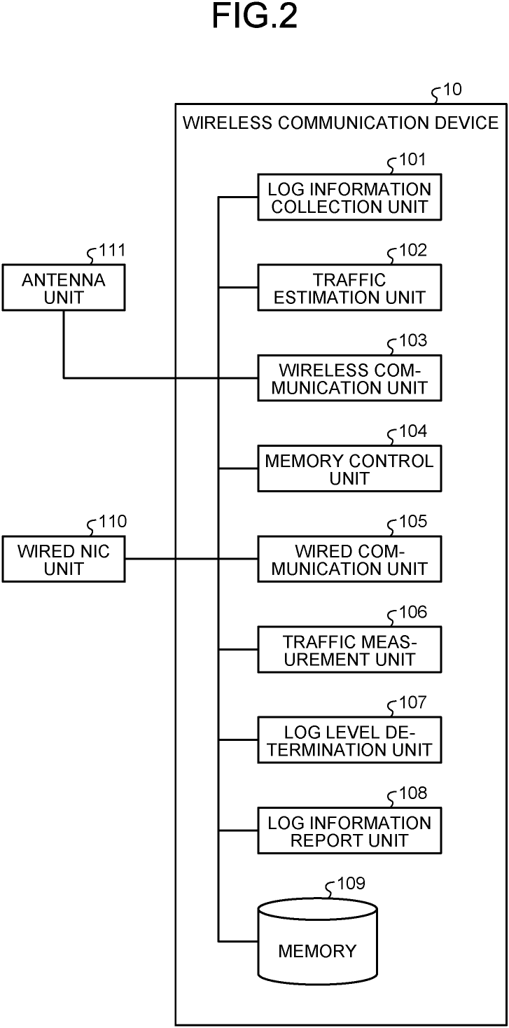

A configuration of the wireless communication device 10 will be described. FIG. 2 is a block diagram illustrating an example of the configuration of the wireless communication device 10 according to the present embodiment. The wireless communication device 10 includes a log information collection unit 101, a traffic estimation unit 102, a wireless communication unit 103, a memory control unit 104, a wired communication unit 105, a traffic measurement unit 106, a log level determination unit 107, a log information report unit 108, a memory 109, a wired network interface card (NIC) unit 110, and an antenna unit 111.

The log information collection unit 101 collects log information at a collection frequency based on a log level determined by the log level determination unit 107. The log information collection unit 101 has a function of collecting, that is, measuring regularly in accordance with a collection cycle, the log information such as wireless communication quality such as received signal power intensity in the wireless interface, a header and a time stamp of application traffic of the control device 30 passing through the wired interface, and a device load such as central processing unit (CPU) utilization and temperature of the wireless communication device 10. The log information collection unit 101 further has a function of storing the collected log information in the memory 109.

The traffic estimation unit 102 has a function of estimating when the application traffic of the control device 30 having cyclicity passes next, that is, estimated passage time thereof, among the application traffic of the control device 30 transferred between the wireless communication unit 103 and the wired communication unit 105. The traffic estimation unit 102 sets the application traffic of the control device 30 having cyclicity from header information or the like of the application traffic of the control device 30. For example, when a packet for time synchronization of the bridge system 1 is known to be transmitted from a master clock every 125 ms, and the packet for time synchronization has passed at time 0:00:00.125, the traffic estimation unit 102 estimates the next passage time, that is, the estimated passage time, of the packet for time synchronization to be 0:00:00.250.

The wireless communication unit 103 performs wireless communication with the wireless network device 20. The wireless communication unit 103 has a wireless interface function of performing transmission/reception processing of a wireless signal that is input/output through the antenna unit 111. The wireless communication unit 103 further has a modem function of performing wireless protocol processing such as wireless access to the wireless network device 20 and transmission of user data. The wireless communication unit 103 further has a function of restoring the time of the wireless communication system 2 from the wireless interface and managing the time as part of the wireless communication system 2. The wireless communication unit 103 further has a function of transferring the application traffic of the control device 30 wirelessly received, to the wired communication unit 105. The wireless communication unit 103 further has a function of wirelessly transmitting the application traffic of the control device 30 transferred from the wired communication unit 105.

The memory control unit 104 has a function of discarding, from the memory 109, the log information that has been stored for a specified period among the log information stored in the memory 109 by the log information collection unit 101. The memory control unit 104 further has a function of discarding, from the memory 109, the log information that has been reported to the wireless network device 20 by the log information report unit 108. The specified period is, for example, a period longer than a report interval that is assumed as a reporting frequency by the log information report unit 108.

The wired communication unit 105 performs wired communication with the TSN 3 by wired communication that corresponds to the TSN 3. The wired communication unit 105 has a wired interface function of performing transmission/reception processing of wired signals that are input/output through the wired NIC units 110. The wired communication unit 105 further has a forwarding function of transmitting, by wire, the application traffic of the control device 30 transferred from the wireless communication unit 103 from the wired NIC unit 110 that is connected to an appropriate one of the TSNs 3 and receiving, by wire, the application traffic of the control device 30 from the wired NIC unit 110. The wired communication unit 105 further has a function of performing time synchronization as part of the TSN 3. The wired communication unit 105 further has a function of performing priority control as part of the TSN 3. Moreover, the wired communication unit 105 has a time stamping function and a function of correcting the packet for time synchronization required for establishing the wireless communication system 2 as the bridge.

The traffic measurement unit 106 measures traffic transferred between the wireless communication unit 103 and the wired communication unit 105. The traffic measurement unit 106 has a function of measuring the passage time of the application traffic of the control device 30 transferred from the wireless communication unit 103 to the wired communication unit 105. The traffic measurement unit 106 further has a function of measuring the passage time of the application traffic of the control device 30 transferred from the wired communication unit 105 to the wireless communication unit 103.

The log level determination unit 107 has a function of calculating a difference Δ between the estimated passage time of the application traffic of the control device 30 estimated by the traffic estimation unit 102 and the actual passage time of the application traffic of the control device 30 measured by the traffic measurement unit 106. The log level determination unit 107 further has a function of determining a log level to be set to the wireless communication device 10 on the basis of the difference Δ. The log level determination unit 107 further has a function of managing a log-level-instruction-value instructed from the wireless network device 20. The log level determination unit 107 further has a function of notifying the log information report unit 108 of the determined log level in order that the determined log level is reported to the wireless network device 20 when the determined log level is greater than or equal to the log-level-instruction-value. The log level determination unit 107 further has a function of changing, on the basis of the log level, the collection cycle of the log information by the log information collection unit 101 and a report cycle of the log information to the wireless network device 20 by the log information report unit 108. In the following description, the log level determined by the log level determination unit 107 may be referred to as a first log level, and the log level indicated by the log-level-instruction-value from the wireless network device 20 may be referred to as a second log level. That is, the log level determination unit 107 determines the log level by using the first log level and the second log level. The first log level is based on the difference Δ between the estimated passage time of the traffic estimated by the traffic estimation unit 102 and the actual passage time of the traffic measured by the traffic measurement unit 106, and the second log level is acquired from the wireless network device 20.

The log information report unit 108 reports the log information to the wireless network device 20 at the reporting frequency based on the log level determined by the log level determination unit 107. The log information report unit 108 has a function of transferring the log information stored in the memory 109 to the wireless communication unit 103 in order to report the log information to the wireless network device 20 in accordance with the reporting cycle. The log information report unit 108 further has a function of notifying the log level determination unit 107 of the log-level-instruction-value instructed from the wireless network device 20, when acquiring the log-level-instruction-value from the wireless communication unit 103. Also, when the log level determination unit 107 has changed the log level to be set to the wireless communication device 10, the log information report unit 108 has a function of transferring the changed log level to the wireless communication unit 103 in order to report the changed log level to the wireless network device 20. Note that the notification of the log-level-instruction-value is made from the wireless communication unit 103 to the log level determination unit 107 via the log information report unit 108, and the notification of the changed log level is made from the log level determination unit 107 to the wireless communication unit 103 via the log information report unit 108, but the way of notification is not limited thereto. Without going through the log information report unit 108, the notification of the log-level-instruction-value may be made from the wireless communication unit 103 to the log level determination unit 107, and the notification of the changed log level may be made from the log level determination unit 107 to the wireless communication unit 103.

The memory 109 has a function of storing setting information such as parameters for the wireless communication device 10 to operate. The memory 109 further has a function of storing, that is, accumulating the log information collected by the log information collection unit 101.

The wired NIC unit 110 has a function of transmitting, by wire, a signal acquired from the wired communication unit 105 to the TSN 3 connected. The wired NIC unit 110 further has a function of outputting a signal received by wire from the TSN 3 to the wired communication unit 105.

The antenna unit 111 has a function of converting a signal acquired from the wireless communication unit 103 into a radio wave and transmitting the radio wave. The antenna unit 111 further has a function of outputting a received signal to the wireless communication unit 103.

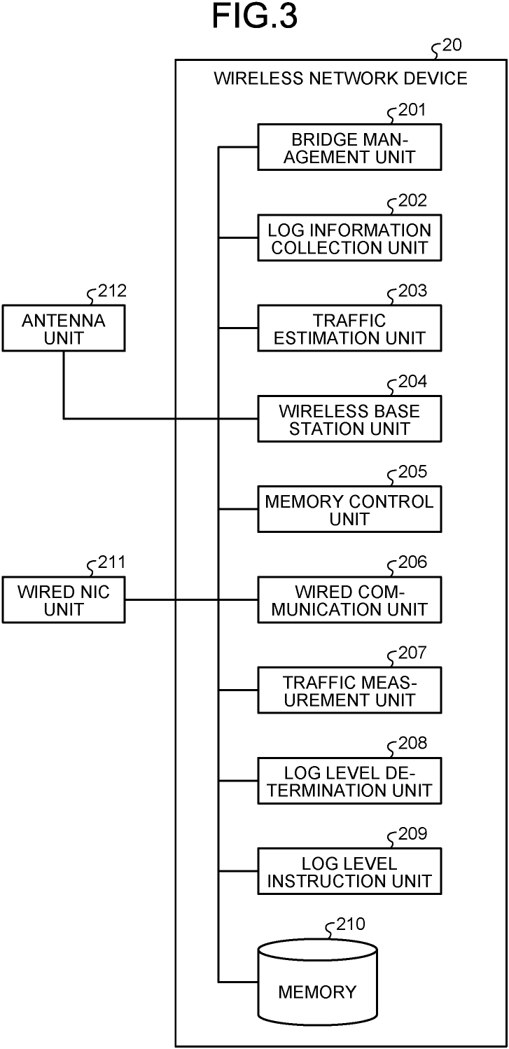

Next, a configuration of the wireless network device 20 will be described. FIG. 3 is a block diagram illustrating an example of the configuration of the wireless network device 20 according to the present embodiment. The wireless network device 20 includes a bridge management unit 201, a log information collection unit 202, a traffic estimation unit 203, a wireless base station unit 204, a memory control unit 205, a wired communication unit 206, a traffic measurement unit 207, a log level determination unit 208, a log level instruction unit 209, a memory 210, a wired NIC unit 211, and an antenna unit 212.

The bridge management unit 201 manages the wireless communication system 2 as the TSN bridge. In order to handle the wireless communication system 2 as the TSN bridge, the bridge management unit 201 has a function of managing information on the wireless communication devices 10, the wired communication unit 206 of the wireless network device 20, and the like, the wireless communication devices 10 and the wireless network device 20 serve as the TSN ports in the wireless communication system 2. The managed information includes combinations of the TSN ports functioning as the TSN bridge, a retention delay time in each combination, and the like.

The log information collection unit 202 collects log information at a collection frequency based on a log level determined by the log level determination unit 208. The log information collection unit 202 has a function of collecting, that is, measuring regularly in accordance with a collection cycle, the log information such as wireless communication quality such as received signal power intensity in the wireless interface, a header and a time stamp of application traffic of the control device 30 passing through the wired interface, and a device load such as CPU utilization and temperature of the wireless network device 20. The log information collection unit 202 further has a function of storing the collected log information in the memory 210.

The traffic estimation unit 203 has a function of estimating when the application traffic of the control device 30 having cyclicity passes next, that is, an estimated passage time thereof, among the application traffic of the control device 30 transferred between the wireless base station unit 204 and the wired communication unit 206. The traffic estimation unit 203 sets the application traffic of the control device 30 having cyclicity from header information or the like of the application traffic of the control device 30. For example, when a packet for time synchronization of the bridge system 1 is known to be transmitted from the master clock every 125 ms, and the packet for time synchronization has passed at time 0:00:00.125, the traffic estimation unit 203 estimates the next passage time of the packet for time synchronization to be 0:00:00.250.

The wireless base station unit 204 performs wireless communication with the wireless communication device 10 and acquires the log information from the wireless communication device 10. The wireless base station unit 204 has a wireless interface function of performing transmission/reception processing of a wireless signal that is input/output through the antenna unit 212. The wireless base station unit 204 further has a modem function of wireless protocol processing such as wireless access and transmission of user data to the wireless communication device 10. The wireless base station unit 204 further has a function of managing time as the master clock of the wireless communication system 2. The wireless base station unit 204 further has a function of transferring the application traffic of the control device 30 wirelessly received to the wired communication unit 206. The wireless base station unit 204 further has a function of wirelessly transmitting the application traffic of the control device 30 transferred from the wired communication unit 206. In the following description, the log information of the wireless communication device 10 may be referred to as first log information, and the log information of the wireless network device 20 collected by the log information collection unit 202 may be referred to as second log information.

The memory control unit 205 has a function of, for example, rearranging and organizing, in the memory 210, the log information stored in the memory 210 by the log information collection unit 202 and the log information reported from the wireless communication device 10.

The wired communication unit 206 performs wired communication with the TSN 3 by wired communication corresponding to the TSN 3. The wired communication unit 206 has a wired interface function of transmission/reception processing of a wired signal that is input/output through the wired NIC unit 211. The wired communication unit 206 further has a forwarding function of transmitting, by wire, the application traffic of the control device 30 transferred from the wireless base station unit 204 from the wired NIC unit 211 connected to an appropriate one of the TSNs 3 and receiving, by wire, the application traffic of the control device 30 from the wired NIC unit 211. The wired communication unit 206 further has a function of time synchronization as part of the TSN 3. The wired communication unit 206 further has a function of performing priority control as part of the TSN 3. Moreover, the wired communication unit 206 has a time stamping function and a function of correcting the packet for time synchronization in order for establishing the wireless communication system 2 as the bridge.

The traffic measurement unit 207 measures traffic transferred between the wireless base station unit 204 and the wired communication unit 206. The traffic measurement unit 207 has a function of measuring the passage time of the application traffic of the control device 30 transferred from the wireless base station unit 204 to the wired communication unit 206. The traffic measurement unit 207 further has a function of measuring the passage time of the application traffic of the control device 30 transferred from the wired communication unit 206 to the wireless base station unit 204.

The log level determination unit 208 has a function of calculating the difference Δ between the estimated passage time of the application of the control device 30 estimated by the traffic estimation unit 203 and the actual passage time of the application traffic of the control device 30 measured by the traffic measurement unit 207. The log level determination unit 208 further has a function of determining a log level to be set to the wireless network device 20 on the basis of the difference Δ. The log level determination unit 208 further has a function of notifying the log level instruction unit 209 of a log-level-instruction-value indicating the determined log level, in order to change the log level of the wireless communication device 10 that is required on the basis of the combination of the TSN ports managed by the bridge management unit 201. The log level determination unit 208 further has a function of changing, on the basis of the log level, the collection cycle of the log information by the log information collection unit 202. That is, the log level determination unit 208 determines the log level by using the first log level reported from the wireless communication device 10 and the second log level. The second log level is based on the difference Δ between the estimated passage time of the traffic estimated by the traffic estimation unit 203 and the actual passage time of the traffic measured by the traffic measurement unit 207.

The log level instruction unit 209 has a function of transferring the log-level-instruction-value to the wireless base station unit 204 in order to indicate the log level determined by the log level determination unit 208 as the log-level-instruction-value to the wireless communication device 10.

The memory 210 has a function of storing setting information such as parameters for the wireless network device 20 to operate. The memory 210 further has a function of storing, that is, accumulating the log information collected by the log information collection unit 202 and the log information reported from the wireless communication device 10. Note that the log information reported from the wireless communication device 10 may be stored in the memory 210 by the wireless base station unit 204, or may be transferred to the log information collection unit 202 or the memory control unit 205 by the wireless base station unit 204 and then stored in the memory 210 by the log information collection unit 202 or the memory control unit 205.

The wired NIC unit 211 has a function of transmitting, by wire, a signal acquired from the wired communication unit 206 to the TSN 3 connected. The wired NIC unit 211 further has a function of outputting a signal received by wire from the TSN 3 to the wired communication unit 206.

The antenna unit 212 has a function of converting a signal acquired from the wireless base station unit 204 into a radio wave and transmitting the radio wave. The antenna unit 212 further has a function of outputting a received signal to the wireless base station unit 204.

Note that FIG. 3 illustrates, as an example, the configuration in which the functional units of the wireless network device 20 are all implemented on the same device, but the configuration is not limited thereto. The functional units of the wireless network device 20 may be distributed and implemented in different devices as long as the functional units are logically connected.

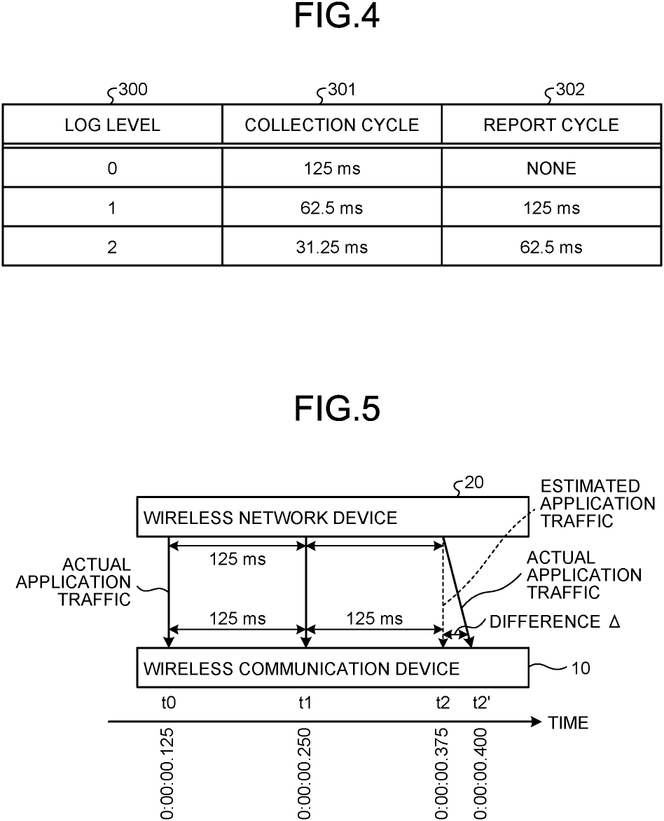

FIG. 4 is a table illustrating examples of parameters for the log level used in the wireless communication device 10 and the wireless network device 20 according to the present embodiment. A log level 300 is a value managed by the wireless communication device 10 and the wireless network device 20, and a collection cycle 301 and a report cycle 302 are determined with respect to the value of the log level 300. The collection cycle 301 is a cycle of measuring, that is, collecting the log information. The report cycle 302 is a cycle of reporting the log information.

When the log level 300 is “0”, the collection cycle 301 is “125 ms”, and the report cycle 302 is “none”. The wireless communication device 10 collects the log information once every 125 ms and does not report the log information. The wireless network device 20 collects the log information once every 125 ms and does not report the log information. When the log level 300 is “1”, the collection cycle 301 is “62.5 ms”, and the report cycle 302 is “125 ms”. The wireless communication device 10 collects the log information once every 62.5 ms and reports the log information once every 125 ms. The wireless network device 20 collects the log information once every 62.5 ms and does not report the log information. When the log level 300 is “2”, the collection cycle 301 is “31.25 ms”, and the report cycle 302 is “62.5 ms”. The wireless communication device 10 collects the log information once every 31.25 ms and reports the log information once every 62.5 ms. The wireless network device 20 collects the log information once every 31.25 ms and does not report the log information. Note that the present embodiment describes, as an example, the log level taking the three values of “0”, “1”, and “2”, but the number of log levels is not limited thereto. The number of log levels may be two or less or four or more.

FIG. 5 is a diagram illustrating an example of calculating the difference Δ between the estimated passage time and the actual passage time of the application traffic of the control device 30 from the wireless network device 20 to the wireless communication device 10 in the wireless communication system 2 according to the present embodiment. After the application traffic of the control device 30 actually passes at time t0, the traffic estimation unit 102 of the wireless communication device 10 estimates the next estimated passage time of the application traffic of the control device 30. It is assumed that the traffic estimation unit 102 knows in advance, from setting, the presence of the application traffic of the control device 30 having a regular cycle of 125 ms. When the application traffic of the control device 30 having the regular cycle has passed through the wireless communication device 10 at the passage time of 0:00:00.125 at time t0, the traffic estimation unit 102 estimates the estimated passage time to be 0:00:00.250 at time t1. Here, if there is no variation in the delay time between the TSN ports in the wireless communication system 2, the next actual passage time of the application traffic of the control device 30 measured by the traffic measurement unit 106 is time t1 as estimated. In this case, the difference Δ is zero because the estimated passage time matches the actual passage time.

Now, a case is assumed in which the delay time varies in the wireless transmission from the wireless network device 20 to the wireless communication device 10 depending on the wireless communication quality, the load status of each device in the wireless communication system 2, and the like. The traffic estimation unit 102 estimates the next estimated passage time after time t1, to be 0:00:00.375 at time t2. However, due to deterioration in the wireless communication quality or the like, the next actual passage time of the application traffic of the control device 30 measured by the traffic measurement unit 106 is 0:00:00.400 at time t2′. In this case, the difference Δ is 25 ms which is a value obtained by subtracting time t2 from time t2′. Note that the variation in the delay time is considered to increase as the number of retransmissions, reconnections, handovers, and the like at the radio level increases, and thus it can be assumed that the larger the difference Δ, the lower the communication quality. The example of FIG. 5 illustrates the case where the wireless communication device 10 calculates the difference Δ in the downlink from the wireless network device 20 to the wireless communication device 10, but also in the uplink from the wireless communication device 10 to the wireless network device 20, the wireless network device 20 calculates the difference Δ by a similar calculation method.

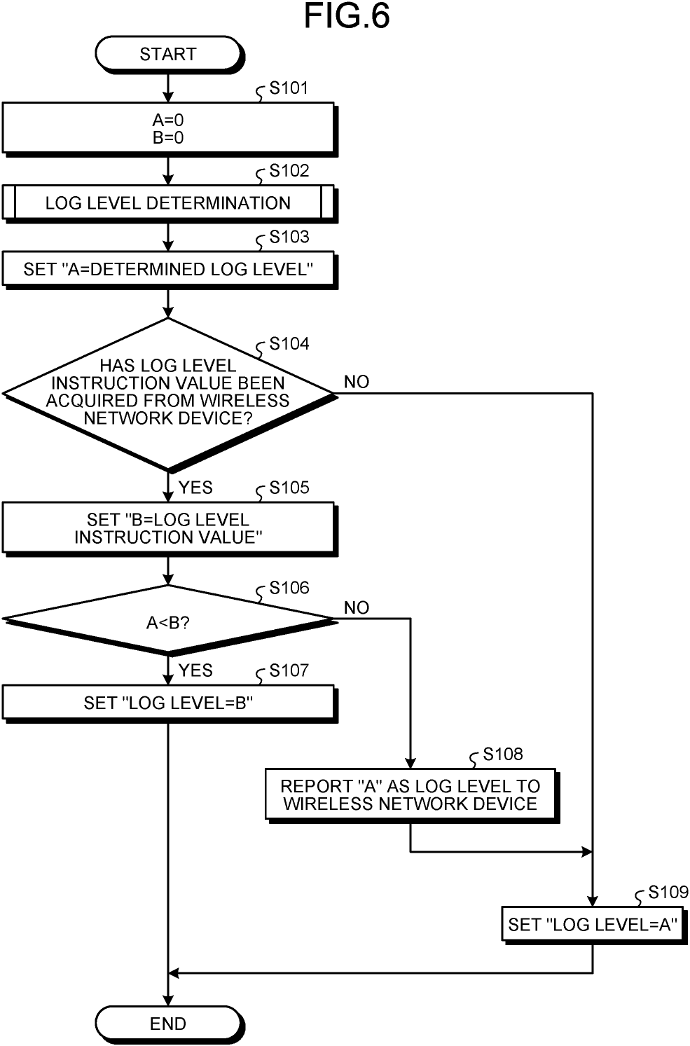

Next, an operation in which the wireless communication device 10 sets the log level will be described. FIG. 6 is a flowchart illustrating the operation in which the wireless communication device 10 according to the present embodiment sets the log level. The wireless communication device 10 executes the flowchart illustrated in FIG. 6 whenever calculating the difference Δ. In the wireless communication device 10, the log level determination unit 107 initializes a variable A and a variable B used in the flowchart (step S101). Specifically, the log level determination unit 107 sets the variables to be A=0 and B=0. The log level determination unit 107 determines the log level to be set in the wireless communication device 10 (step S102). A method of determining the log level by the log level determination unit 107 will be described later. The log level determination unit 107 substitutes the determined log level for the variable A (step S103). The log level determination unit 107 determines whether or not a log-level-instruction-value has been acquired from the wireless network device 20 (step S104).

If the log-level-instruction-value has been acquired from the wireless network device 20 (Yes in step S104), the log level determination unit 107 substitutes the log-level-instruction-value for the variable B (step S105). The log level determination unit 107 compares the variable A with the variable B (step S106). If the variable B is larger than the variable A (Yes in step S106), the log level determination unit 107 substitutes the variable B for the log level to be set in the wireless communication device 10 (step S107). That is, the log level determination unit 107 sets the log-level-instruction-value as the log level to be set in the wireless communication device 10. If the variable A is larger than or equal to the variable B (No in step S106), the log level determination unit 107 reports the variable A as the log level of the wireless communication device 10 to the wireless network device 20 via the log information report unit 108 and the wireless communication unit 103 (step S108). The log level determination unit 107 substitutes the variable A for the log level to be set in the wireless communication device 10 (step S109). Note that if the log-level-instruction-value has not been acquired from the wireless network device 20 (No in step S104), the log level determination unit 107 similarly substitutes the variable A for the log level to be set in the wireless communication device 10 (step S109). That is, the log level determination unit 107 sets the determined log level as the log level to be set in the wireless communication device 10.

As described above, the log level determination unit 107 compares the first log level with the second log level. When the first log level is greater than or equal to the second log level, the log level determination unit 107 performs control to report the first log level to the wireless network device 20, and also sets the first log level as the log level for controlling the collection frequency of the log information by the log information collection unit 101 and the reporting frequency of the log information by the log information report unit 108. When the first log level is less than the second log level, the log level determination unit 107 sets the second log level as the log level for controlling the collection frequency of the log information by the log information collection unit 101 and the reporting frequency of the log information by the log information report unit 108.

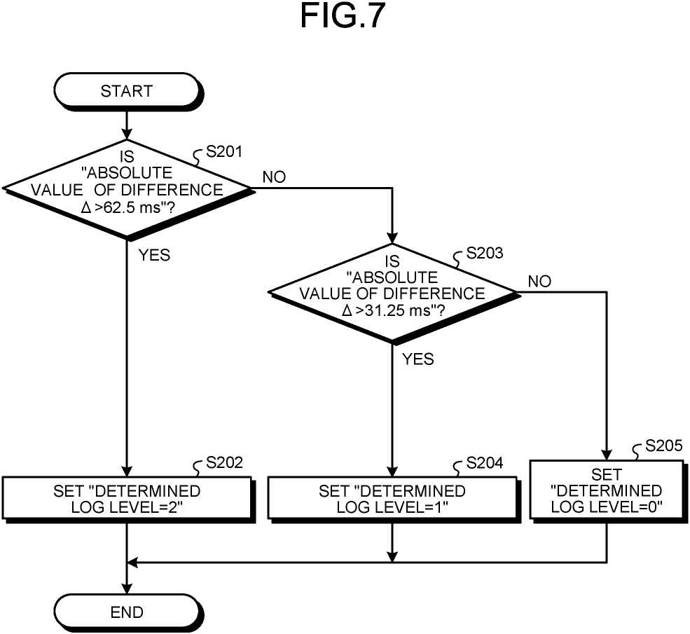

Next, an operation in which the wireless communication device 10 and the wireless network device 20 determine the log level will be described. FIG. 7 is a flowchart illustrating the operation in which the wireless communication device 10 and the wireless network device 20 according to the present embodiment determine the log level. The operation of the flowchart illustrated in FIG. 7 is performed by the log level determination unit 107 in the wireless communication device 10, and by the log level determination unit 208 in the wireless network device 20. Hereinafter, as an example, the log level determination unit 107 in the wireless communication device 10 will be mainly described. The operation of the flowchart illustrated in FIG. 7 illustrates details of the operation in step S102 of the flowchart illustrated in FIG. 6 described above.

In the wireless communication device 10, the log level determination unit 107 compares an absolute value of a calculated difference Δ with 62.5 ms (step S201). If the absolute value of the difference Δ is larger than 62.5 ms (Yes in step S201), the log level determination unit 107 sets the determined log level to “2” (step S202). If the absolute value of the difference Δ is less than or equal to 62.5 ms (No in step S201), the log level determination unit 107 compares the absolute value of the calculated difference Δ with 31.25 ms (step S203). If the absolute value of the difference Δ is larger than 31.25 ms (Yes in step S203), the log level determination unit 107 sets the determined log level to “1” (step S204). If the absolute value of the difference Δ is less than or equal to 31.25 ms (No in step S203), the log level determination unit 107 sets the determined log level to “0” (step S205). In the present embodiment, the operation of determining the log level is represented by a simple flowchart with branches as many as the number of log levels, but the value used for the branch determination in each of steps S201 and S203 is desirably set to an appropriate value depending on the cycle of an application having a regular cycle. Moreover, in the present embodiment, the absolute value of the immediately preceding difference Δ is used for the determination, but in order to avoid a situation in which the determined log level is changed frequently, a moving average value of the difference Δ having an appropriate constraint length may be used for the determination.

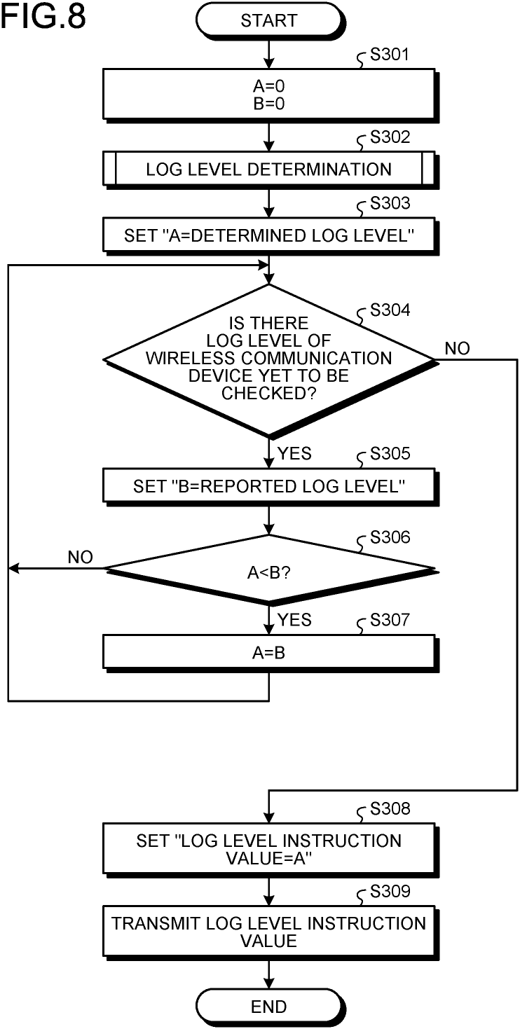

Next, an operation in which the wireless network device 20 transmits the log-level-instruction-value to the wireless communication device 10 will be described. FIG. 8 is a flowchart illustrating the operation in which the wireless network device 20 according to the present embodiment transmits the log-level-instruction-value to the wireless communication device 10. In the wireless network device 20, the log level determination unit 208 initializes a variable A and a variable B used in the flowchart (step S301). Specifically, the log level determination unit 208 sets the variables to be A=0 and B=0. The log level determination unit 208 determines the log level to be set in the wireless network device 20 (step S302). The operation in which the log level determination unit 208 determines the log level to be set in the wireless network device 20, is the same as the operation of the flowchart illustrated in FIG. 7 described above. The log level determination unit 208 substitutes the determined log level for the variable A (step S303). The log level determination unit 208 determines whether or not there is a log level reported from the wireless communication device 10 involved in the TSN bridge and there is a log level of the wireless communication device 10 yet to be checked (step S304).

If there is a log level reported from the wireless communication device 10 and a log level of the wireless communication device 10 yet to be checked (Yes in step S304), the log level determination unit 208 substitutes the reported log level for the variable B (step S305). The log level determination unit 208 compares the variable A with the variable B (step S306). If the variable B is larger than the variable A (Yes in step S306), the log level determination unit 208 substitutes the variable B for the variable A (step S307), and returns to step S304. If the variable A is larger than or equal to the variable B (No in step S306), the log level determination unit 208 returns to step S304. In steps S304 to S307, the log level determination unit 208 determines whether or not log levels have been reported from all the wireless communication devices 10 involved in the TSN bridge, compares the reported log levels with the variable A, and substitutes the maximum value for the variable A. Note that the log level determination unit 208 can specify the wireless communication devices 10 involved in the TSN bridge, that is, the wireless communication devices 10 involved in the combinations of the TSN ports, by using the information managed by the bridge management unit 201.

If there is no log level reported from the wireless communication device 10, or if there is a log level reported from the wireless communication device 10 but no log level of the wireless communication device 10 yet to be checked (No in step S304), the log level determination unit 208 substitutes the variable A for the log-level-instruction-value (step S308). The log level determination unit 208 notifies the log level instruction unit 209 that the variable A is instructed as the log-level-instruction-value. The log level instruction unit 209 specifies the target wireless communication device 10 to which the log-level-instruction-value is transmitted by using the information managed by the bridge management unit 201, and transmits the variable A as the log-level-instruction-value to the wireless communication device 10 specified via the wireless base station unit 204 (step S309).

As described above, the log level determination unit 208 compares the first log level with the second log level. When the second log level is greater than or equal to the first log level, the log level determination unit 208 sets the second log level as the log level for controlling the collection frequency of the log information by the log information collection unit 202. When the second log level is less than the first log level, the log level determination unit 208 sets the first log level as the log level for controlling the collection frequency of the log information by the log information collection unit 202. The log level determination unit 208 notifies the log level instruction unit 209 of the log level. The log level instruction unit 209 transmits the log level notified from the log level determination unit 208 as the log-level-instruction-value to the wireless communication device 10 via the wireless base station unit 204.

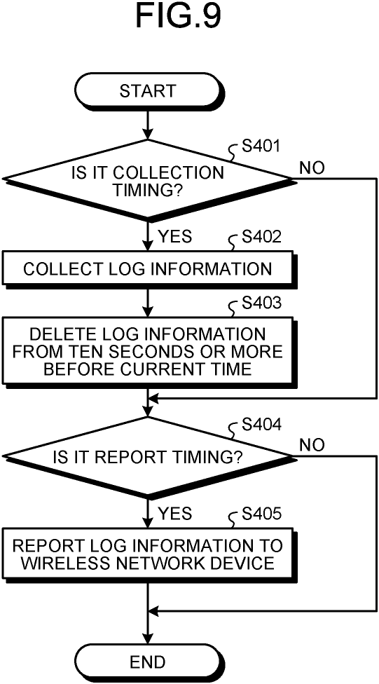

Next, an operation in which the wireless communication device 10 collects log information and reports the log information will be described. FIG. 9 is a flowchart illustrating the operation in which the wireless communication device 10 according to the present embodiment collects log information and reports the log information.

In the wireless communication device 10, the log information collection unit 101 determines whether or not the current time is a collection timing for collecting log information (step S401). If the current time is the collection timing (Yes in step S401), the log information collection unit 101 collects the log information (step S402). The log information collection unit 101 stores the collected log information in the memory 109. In order to reduce or prevent an increase in the device load on the wireless communication device 10, pressing the memory 109, and the like, the memory control unit 104 deletes, from the memory 109, the log information that has been stored for a specified period such as, as an example, the log information from ten seconds or more before the current time (step S403). While ten seconds is set in the present embodiment, it is desirable to set an appropriate value taking into account the time required for a change in the log-level-instruction-value from the wireless network device 20 to spread throughout the wireless communication system 2.

If the current time is not the collection timing (No in step S401), or after the operation of step S403, the log information report unit 108 in the wireless communication device 10 determines whether or not the current time is a report timing (step S404). If the current time is the report timing (Yes in step S404), the log information report unit 108 reports the log information stored in the memory 109 to the wireless network device 20 via the wireless communication unit 103 (step S405). If the current time is not the report timing (No in step S404), the wireless communication device 10 ends the operation. Note that the wireless communication device 10 executes the operation of the flowchart illustrated in FIG. 9 with a cycle shorter than the cycle that can be set for the collection cycle of the log information and the report cycle of the log information.

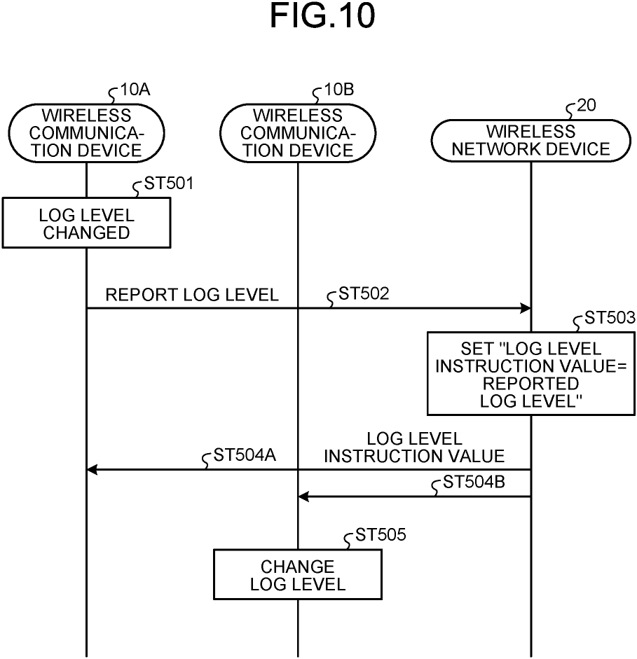

Next, a description will be made of an operation of changing the log level of each device in the wireless communication system 2 in response to a report of the log level from the wireless communication device 10 in the wireless communication system 2. FIG. 10 is a sequence diagram illustrating the operation of changing the log level of each device in the wireless communication system 2 in response to a report from the wireless communication device 10 in the wireless communication system 2 according to the present embodiment. In FIG. 10, wireless communication devices 10A and 10B have configurations similar to that of the wireless communication device 10 described above. Here, it is assumed that the wireless network device 20 has already transmitted the log level “0” as the log-level-instruction-value to the wireless communication devices 10A and 10B. When the log level is changed (step ST501), the wireless communication device 10A reports the log level to the wireless network device 20 (step ST502). The operations of step ST501 and step ST502 illustrated in FIG. 10 correspond to the operations in the case of “No” in step S106 and step S108 in the flowchart illustrated in FIG. 6.

Because the log level reported from the wireless communication device 10A is larger than the log level “0” transmitted as the log-level-instruction-value, the wireless network device 20 determines to set the log level reported from the wireless communication device 10A as the log-level-instruction-value. That is, the wireless network device 20 substitutes the log level reported from the wireless communication device 10A as the variable A for the log-level-instruction-value (step ST503). The operation of step ST503 illustrated in FIG. 10 corresponds to the operations in the case of “Yes” in step S304, step S305, “Yes” in step S306, step S307, and step S308 in the flowchart illustrated in FIG. 8. The wireless network device 20 specifies the wireless communication devices 10A and 10B to which the log-level-instruction-value is transmitted by using the information managed by the bridge management unit 201, and transmits the log-level-instruction-value to the specified wireless communication devices 10A and 10B (steps ST504A and ST504B). The operations of steps ST504A and ST504B illustrated in FIG. 10 correspond to the operation of step S309 in the flowchart illustrated in FIG. 8.

The wireless communication device 10B changes the log level on the basis of the log-level-instruction-value acquired from the wireless network device 20 (step ST505). The operation of step ST505 illustrated in FIG. 10 corresponds to the operations in the case of “Yes” in step S106 and step S107 in the flowchart illustrated in FIG. 6. With the operation of the sequence diagram illustrated in FIG. 10, in the wireless communication system 2, when the wireless communication device 10A has changed the log level, the wireless communication device 10B related to the wireless communication device 10A in the TSN bridge can change the log level to the log level similar to that of the wireless communication device 10A. Thus, the wireless communication device 10B can collect and report the log information with granularity similar to that in the wireless communication device 10A.

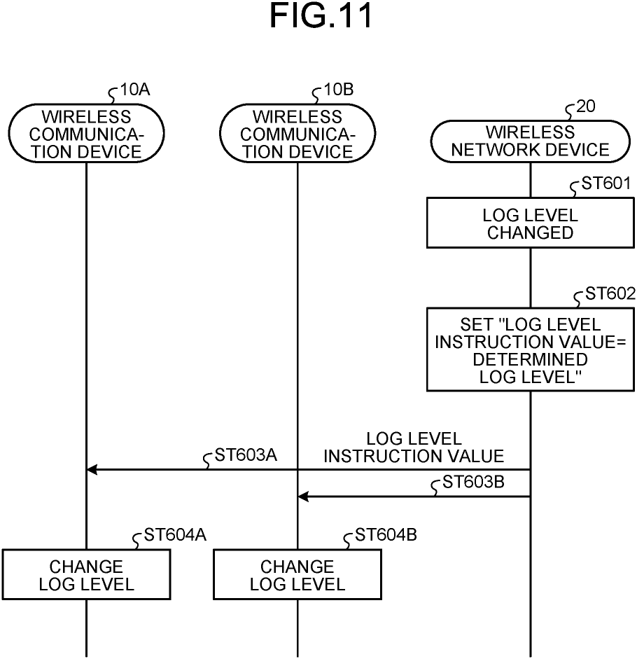

Next, a description will be made of an operation of changing the log levels of the wireless communication devices 10A and 10B in the wireless communication system 2 on the basis of the log-level-instruction-value from the wireless network device 20 in the wireless communication system 2. FIG. 11 is a sequence diagram illustrating the operation of changing the log levels of the wireless communication devices 10A and 10B on the basis of the log-level-instruction-value from the wireless network device 20 in the wireless communication system 2 according to the present embodiment.

When the log level has been changed (step ST601), the wireless network device 20 determines to set the determined log level of the wireless network device 20 as the log-level-instruction-value. That is, the wireless network device 20 substitutes the determined log level as the variable A for the log-level-instruction-value (step ST602). The operation of step ST601 illustrated in FIG. 11 corresponds to the operations from step S301 to step S307 in the flowchart illustrated in FIG. 8. The operation of step ST602 illustrated in FIG. 11 corresponds to the operation of step S308 in the flowchart illustrated in FIG. 8. The wireless network device 20 specifies, by using the information managed by the bridge management unit 201, the target wireless communication devices 10A and 10B to which the log-level-instruction-value is transmitted, and transmits the log-level-instruction-value to the specified wireless communication devices 10A and 10B (steps ST603A and ST603B). The operations of steps ST603A and ST603B illustrated in FIG. 11 correspond to the operation in the case of step S309 in the flowchart illustrated in FIG. 8.

The wireless communication device 10A changes the log level on the basis of the log-level-instruction-value acquired from the wireless network device 20 (step ST604A). The wireless communication device 10B changes the log level on the basis of the log-level-instruction-value acquired from the wireless network device 20 (step ST604B). The operations of steps ST604A and ST604B illustrated in FIG. 11 correspond to the operations in the case of “Yes” in step S106 and step S107 in the flowchart illustrated in FIG. 6. With the operation of the sequence diagram illustrated in FIG. 11, in the wireless communication system 2, the wireless network device 20 can cause the wireless communication devices 10A and 10B involved in the TSN bridge managed by the wireless network device 20 to change the log levels so that the wireless communication devices 10A and 10B collect the log information with granularity similar to that in the wireless network device 20.

Next, a hardware configuration of the wireless communication device 10 will be described. In the wireless communication device 10, the antenna unit 111 is implemented by an antenna element. The wired NIC unit 110 is implemented by an interface card. The memory 109 is implemented by a memory. The other configurations in the wireless communication device 10 are implemented by processing circuitry. The processing circuitry may include a memory and a processor executing a program stored in the memory, or may include dedicated hardware. The processing circuitry is also called a control circuit.

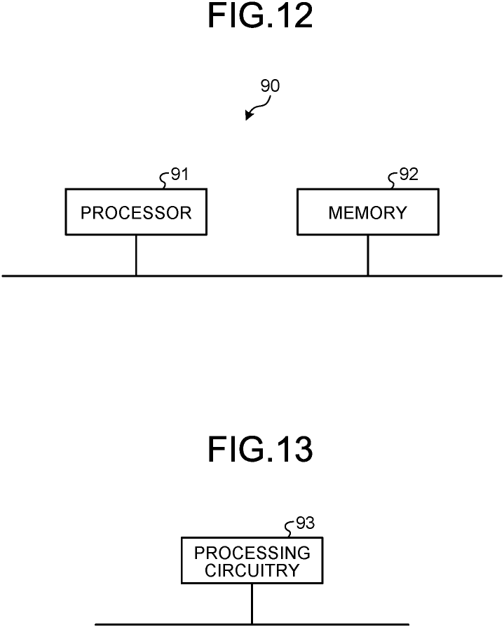

FIG. 12 is a diagram illustrating an example of a configuration of processing circuitry 90 in a case where the processing circuitry included in the wireless communication device 10 according to the present embodiment is implemented by a processor 91 and a memory 92. The processing circuitry 90 illustrated in FIG. 12 is a control circuit and includes the processor 91 and the memory 92. When the processing circuitry 90 incudes the processor 91 and the memory 92, the functions of the processing circuitry 90 are implemented by software, firmware, or a combination of software and firmware. The software or firmware is described as a program and stored in the memory 92. The processing circuitry 90 implements the functions by the processor 91 reading and executing the program stored in the memory 92. That is, the processing circuitry 90 includes the memory 92 for storing the program that result in the execution of the processing of the wireless communication device 10. It can also be said that this program is a program for causing the wireless communication device 10 to execute the functions implemented by the processing circuitry 90. This program may be provided by a storage medium storing the program, or may be provided by other means such as a communication medium.

The above program can also be said to be a program that causes the wireless communication device 10 to execute: a first step in which the traffic measurement unit 106 measures traffic transferred between the wireless communication unit 103 that performs wireless communication with the wireless network device 20 and the wired communication unit 105 that performs wired communication with the TSN 3; a second step in which the traffic estimation unit 102 estimates an estimated passage time of traffic having cyclicity among the traffic; a third step in which the log level determination unit 107 determines a log level by using a first log level, which is based on the difference Δ between the estimated passage time of the traffic estimated by the traffic estimation unit 102 and an actual passage time of the traffic measured by the traffic measurement unit 106, and a second log level acquired from the wireless network device 20; a fourth step in which the log information collection unit 101 collects log information at a collection frequency based on the log level; and a fifth step in which the log information report unit 108 reports the log information to the wireless network device 20 at a reporting frequency based on the log level.

Here, the processor 91 is, for example, a CPU, a processing unit, an arithmetic unit, a microprocessor, a microcomputer, a digital signal processor (DSP), or the like. Moreover, the memory 92 corresponds to, for example, a non-volatile or volatile semiconductor memory such as a random access memory (RAM), a read only memory (ROM), a flash memory, an erasable programmable ROM (EPROM), or an electrically EPROM (EEPROM (registered trademark)), a magnetic disk, a flexible disk, an optical disk, a compact disc, a mini disc, a digital versatile disc (DVD), or the like.

FIG. 13 is a diagram illustrating an example of processing circuitry 93 in a case where the processing circuitry included in the wireless communication device 10 according to the present embodiment includes dedicated hardware. The processing circuitry 93 illustrated in FIG. 13 corresponds to, for example, a single circuit, a complex circuit, a programmed processor, a parallel-programmed processor, an application specific integrated circuit (ASIC), a field programmable gate array (FPGA), or a combination thereof. The processing circuitry may be implemented partly by dedicated hardware and partly by software or firmware. The processing circuitry can thus implement the functions described above by the dedicated hardware, software, firmware, or a combination thereof.

Note that the wireless network device 20 is also implemented by a hardware configuration similar to that of the wireless communication device 10. In the wireless network device 20, the antenna unit 212 is implemented by an antenna element. The wired NIC unit 211 is implemented by an interface card. The memory 210 is implemented by a memory. The other configurations in the wireless network device 20 are implemented by processing circuitry. The processing circuitry may include a memory and a processor executing a program stored in the memory, or may include dedicated hardware.

As described above, according to the present embodiment, in the wireless communication system 2, the wireless communication device 10 predicts anomaly such as deterioration in the wireless communication quality on the basis of the difference Δ between the estimated passage time and the actual passage time of the application traffic of the control device 30 passing through the wireless communication device 10, switches the log level to adjust the collection frequency of the log information and the reporting frequency of the log information, and reports the log level to the wireless network device 20. Upon acquiring the report of the log level from the wireless communication device 10, the wireless network device 20 transmits the log-level-instruction-value for changing the log level to another one of the wireless communication devices 10.

As a result, the wireless network device 20 and the another one of the wireless communication devices 10 that has acquired the log-level-instruction-value from the wireless network device 20 can change the log level to the same log level as that of the wireless communication device 10 that has reported the log level. Each device in the wireless communication system 2 can synchronously collect the log information at a similar collection frequency on the basis of the same log level, and each of the wireless communication devices 10 in the wireless communication system 2 can synchronously report the log information at a similar reporting frequency on the basis of the same log level. In the wireless communication system 2, the wireless network device 20 can synchronously acquire the log information from the wireless communication devices 10 while reducing or preventing the wireless communication devices 10 from having an increased load, pressing the wireless band, and the like. Thus, the wireless communication devices 10 can each collect and report the log information such that the wireless network device 20 can acquire pieces of the log information mutually synchronized from the plurality of the wireless communication devices 10 while reducing or preventing the wireless communication devices 10 from having an increased load and pressing the wireless band.

The wireless communication device according to the present disclosure has an effect of being able to collect and report the log information such that the wireless network device can acquire pieces of the log information mutually synchronized from the plurality of the wireless communication devices while preventing the wireless communication device from having an increased load and pressing the wireless band in the wireless communication system including the wireless network device and the plurality of the wireless communication devices.

The configuration illustrated in the above embodiment merely illustrates an example, and thus another known technique can be combined, embodiments can be combined together, or the configuration can be partially omitted and/or modified without departing from the scope of the present disclosure.

What is claimed is:

1. A wireless communication device included in a wireless communication system together with a wireless network device, the wireless communication device comprising:
processing circuitry
to measure traffic transferred between the wireless network device and a time sensitive network, the processing circuitry performing wireless communication with the wireless network device and wired communication with the time sensitive network;
to estimate an estimated passage time of the traffic that has cyclicity among the traffic;
to determine a log level by using a first log level, which is based on a difference between the estimated passage time of the traffic estimated and an actual passage time of the traffic measured, and a second log level acquired from the wireless network device;
to collect log information at a collection frequency based on the log level; and
to report the log information to the wireless network device at a reporting frequency based on the log level.

2. The wireless communication device according to claim 1, wherein
the processing circuitry compares the first log level with the second log level and,
when the first log level is greater than or equal to the second log level, performs control to report the first log level to the wireless network device and sets the first log level as the log level and,
when the first log level is less than the second log level, sets the second log level as the log level.

3. The wireless communication device according to claim 1, comprising:
a memory to store the log information; and
the processing circuitry discards, among the log information stored in the memory, the log information that is stored for a specified period and the log information that is already reported, wherein
the specified period is a period longer than a report interval assumed as the reporting frequency.

4. A wireless network device included in a wireless communication system together with a wireless communication device, the wireless network device comprising:
processing circuitry
to measure traffic transferred between the wireless communication device and a time sensitive network, the processing circuitry performing wireless communication with the wireless communication device to acquire first log information from the wireless communication device, and wired communication with a time sensitive network;
to estimate an estimated passage time of the traffic that has cyclicity among the traffic;
to determine a log level by using a first log level that is reported from the wireless communication device and a second log level, which is based on a difference between the estimated passage time of the traffic estimated and an actual passage time of the traffic measured;
to instruct the wireless communication device that the log level determined is used as a log-level-instruction-value;
to collect second log information of the wireless network device at a collection frequency based on the log level; and
to manage the wireless communication system as a bridge.

5. The wireless network device according to claim 4, wherein
the processing circuitry compares the first log level with the second log level,
to set the second log level as the log level when the second log level is greater than or equal to the first log level or set the first log level as the log level when the second log level is less than the first log level,
transmits the log level set to the wireless communication device as the log-level-instruction-value.

6. A wireless communication system comprising:
a wireless communication device comprising:
processing circuitry
to measure traffic transferred between the wireless network device and a time sensitive network, the processing circuitry performing wireless communication with the wireless network device and wired communication with the time sensitive network;
to estimate an estimated passage time of the traffic that has cyclicity among the traffic;
to determine a log level by using a first log level, which is based on a difference between the estimated passage time of the traffic estimated and an actual passage time of the traffic measured, and a second log level acquired from the wireless network device;
to collect log information at a collection frequency based on the log level; and
to report the log information to the wireless network device at a reporting frequency based on the log level; and
the wireless network device according to claim 4, wherein
the wireless communication system operates as a bridge for time sensitive networks, manages the wireless communication device and the wireless network device as a combination of time sensitive network ports, and uniformly changes log levels of the wireless communication device and the wireless network device to collect log information.

7. A bridge system comprising:
the wireless communication system according to claim 6; and
a plurality of time sensitive networks, wherein
the wireless communication system serves as a bridge to transfer traffic between control devices placed in different ones of the time sensitive networks, and
the traffic between the control devices has a regular cycle.

8. A control circuit to control a wireless communication device included in a wireless communication system together with a wireless network device, the control circuit causing the wireless communication device to execute:
measuring traffic transferred between the wireless network device and a time sensitive network, the control circuit performing wireless communication with the wireless network device and wired communication with a time sensitive network;
estimating an estimated passage time of the traffic that has cyclicity among the traffic;
determining a log level by using a first log level, which is based on a difference between the estimated passage time of the traffic estimated and an actual passage time of the traffic measured, and a second log level acquired from the wireless network device;
collecting log information at a collection frequency based on the log level; and
reporting the log information to the wireless network device at a reporting frequency based on the log level.
